(19) United States
(12) Patent Application Publication
(10) Pub. No.: US 2014/0355124 A1
(43) Pub. Date: Dec. 4, 2014

(54) COLOR IMPROVING FILM AND METHOD OF MANUFACTURING THE SAME

(71) Applicant: Samsung Electronics Co., Ltd., Suwon-Si (KR)

(72) Inventors: Young-hyun JU, Uiwang-si (KR); Hyun-min KIM, Uiwang-si (KR); Young OH, Uiwang-si (KR); Seung-man CHOI, Uiwang-si (KR); You-min SHIN, Gumi-si (KR); Hong-shik SHIM, Seoul (KR); Chul-ho JEONG, Hwaseong-si (KR); Eun-young CHO, Gumi-si (KR)

(73) Assignee: Samsung Electronics Co., Ltd., Suwon-Si (KR)

(21) Appl. No.: 14/293,333

(22) Filed: Jun. 2, 2014

(30) Foreign Application Priority Data
Jun. 3, 2013 (KR) 10-2013-0063751

(51) Int. Cl. G02B 5/02; B05D 5/06; B05D 3/06; G02B 3/00

(52) U.S. Cl. CPC G02B 5/0242; G02B 3/0037; B05D 5/06; B05D 3/067
USPC 359/599; 427/164; 427/508

(57) ABSTRACT

Provided are a color improving film and a method of manufacturing the color improving film. The color improving film includes a base layer, a high refractive light diffusion layer comprising a light diffuser, a high refractive resin layer, and a low refractive resin layer in which a lenticular lens pattern is formed, wherein the base layer, the high refractive light diffusion layer, the high refractive resin layer, and the low refractive resin layer are stacked, wherein the lenticular lens pattern is formed on a surface of the low refractive resin layer facing the high refractive resin layer, and a unit lenticular lens of the lenticular lens pattern is an oval lenticular lens, wherein the color improving film satisfies 0.10<Δn<0.20, Δn=n1−n2, where n1 denotes a refractive index of the high refractive resin layer, and n2 denotes a refractive index of the low refractive resin layer.

### RELATED APPLICATIONS

This application claims priority from Korean Patent Application No. 10-2013-0063751, filed on Jun. 3, 2013, in the Korean Intellectual Property Office, the disclosure of which is incorporated herein in its entirety by reference.

### BACKGROUND

1. Field

Example embodiments relate to color improving films and/or methods of manufacturing the films, to color improving films whereby wide angle dependency according to a viewing angle is reduced and color reversal effect and blurring effect are reduced, and/or a method of manufacturing the color improving films.

2. Description of the Related Art

A liquid crystal display (LCD) has a structure in which a panel including liquid crystals that are arranged to form a screen is disposed in a tempered glass and a backlight disposed behind the panel emits light to represent a color image. Though the LCD has a high image quality and incurs low manufacturing costs, LCD has process complexity, low response speed, narrow viewing angle, and high power consumption, which have been continuously pointed out as drawbacks. Thus, there is a continuous need for development of a new display.

An organic light-emitting display (OLED) is being noticed as a next-generation display that supplements drawbacks of an LCD. An organic light-emitting display represents colors by using a light emission phenomenon where light is emitted when current flows through a fluorescent organic compound and R (red), G (green), and B (blue) color lights are emitted according to organic materials. An organic light-emitting display has a high resolution and a wide viewing angle, may require low power consumption, and has a high response speed, thus no after-image is generated and natural images are realized. Thus, the organic light-emitting display is widely used not only in portable devices but also in general digital TVs. However, an organic light-emitting display such as an organic light-emitting display (OLED) TV may exhibit a change in color sensitivity according to a viewing angle.

A color improving film may minimize a change in a wide angle dependency (WAD) according to a viewing angle, and may uniformly represent white sensitivity by a degree of minimization. However, in an OLED, which is based on pixel units, light emitted from pixels may spread over adjacent pixels, which may cause blurring.

### SUMMARY

Example embodiments relate to color improving films with a small change in color sensitivity according to a viewing angle.

Example embodiments relate to color improving films with an excellent light transmittivity.

Example embodiments relate to color improving films having excellent light transmittivity.

Example embodiments relate to color improving films with a reduced color reversal effect and a reduced blurring effect.

Example embodiments relate to methods of manufacturing color improving films with improved processibility and economic efficiency.

Additional example embodiments will be set forth in part in the description which follows and, in part, will be apparent from the description, or may be learned by practice of the example embodiments.

According to an example embodiment, a color improving film includes a base layer, a high refractive light diffusion layer comprising a light diffuser, a high refractive resin layer, and a low refractive resin layer in which a lenticular lens pattern is formed, wherein the base layer, the high refractive light diffusion layer, the high refractive resin layer, and the low refractive resin layer are stacked, wherein the lenticular lens pattern is formed on a surface of the low refractive resin layer facing the high refractive resin layer, and a unit lenticular lens of the lenticular lens pattern is an oval lenticular lens, and wherein the color improving film satisfies the following equation (Formula 1):

0.10<Δn<0.20, Δn=n1−n2, [Formula 1]

where n1 denotes a refractive index of the high refractive resin layer, and n2 denotes a refractive index of the low refractive resin layer.

The oval lenticular lens pattern may have a width D of 1 μm to 1000 μm, a height H of 1 μm to 3000 μm, and an aspect ratio H/D of 0.3 to 1.5.

The light diffuser may include an organic light diffuser, an inorganic light diffuser, or a combination of organic and inorganic light diffusers, and the organic light diffuser may include at least one of acrylic particles, siloxane-based particles, melamine-based particles, polycarbonate-based particles, and styrene-based particles.

The organic light diffuser may include spherical particles having an average particle diameter (D50) of about 1 μm to about 20 μm.

The light diffuser may be included in the high refractive light diffusion layer in about 0.1 wt % to about 10 wt %.

The high refractive light diffusion layer and the high refractive resin layer may include an ultraviolet hardening transparent resin having a refractive index of about 1.50 to about 1.60.

The low refractive resin layer may include an ultraviolet hardening transparent resin having a refractive index of about 1.35 to about 1.45.

The lenticular lens pattern and the low refractive resin layer may be integrally formed, e.g. formed as a single unit.

The high refractive light diffusion layer, which includes the light diffuser, and the high refractive resin layer may be integrally formed, e.g. formed as a single unit.

The high refractive resin layer and the low refractive resin layer may include an ultraviolet hardening resin having an acrylate functional group.

A thickness of the base layer may be about 30 μm to about 200 μm, a thickness of the high refractive light diffusion layer may be about 5 μm to 60 μm, a maximum thickness of the high refractive resin layer may be about 5 μm to 80 μm, and a thickness of the low refractive resin layer may be about 5 μm to 50 μm.

The color improving film may further include an adhesive layer that is stacked on the other surface of the low refractive resin layer.

The base layer may include triacetate cellulose (TAC), polyethylene terephthalate (PET), polycarbonate (PC), or poly vinyl chloride (PVC).

According to another example embodiment, an organic light-emitting display may include the color improving film described above.

According to another example embodiment, a method of manufacturing a color improving film, includes forming a high refractive light diffusion layer by spreading a resin including a light diffuser on a surface of a base layer and hardening the resin, forming a high refractive resin layer comprising an engraved lenticular lens pattern on a surface of the high refractive diffusion layer, and forming a low refractive resin layer on a surface of the high refractive resin layer, in which a lenticular lens pattern is engraved, with a low refractive transparent resin, and hardening the low refractive transparent resin layer so that the low refractive resin layer has a lenticular lens pattern on a surface of the low refractive resin layer.

The example method may further include forming an adhesive layer by spreading an adhesive on the other surface of the low refractive resin layer.

The high refractive resin layer may include an ultraviolet hardening transparent resin having a refractive index of about 1.50 to about 1.60, and the low refractive transparent resin may include an ultraviolet hardening transparent resin having a refractive index of about 1.35 to about 1.45.

According to another example embodiment, an organic light-emitting display includes the color improving film described above.

According to the color improving film of the example embodiments, a change in color sensitivity according to a viewing angle is small, and color reversal effects and blurring effects may be reduced or prevented. Also, the color improving film has improved light transmittivity and a manufacturing method thereof has an improved processibility and a high economic efficiency.

### BRIEF DESCRIPTION OF THE DRAWINGS

These and/or other example embodiment will become apparent and more readily appreciated from the following description, taken in conjunction with the accompanying drawings in which:

FIGS. 1A through 1C are graphs respectively showing a color change ratio, a luminance change ratio, and a blurring effect of a panel to which a color improving film is applied according to an example embodiment, and of a bare panel to which no color improving film is applied, with respect to the viewing angle;

FIG. 2 is a cross-sectional view illustrating a color improving film according to an example embodiment;

FIG. 3 is a perspective view illustrating a lenticular lens pattern according to an example embodiment;

FIG. 4A is a graph showing a cross-section of a lenticular lens having an ellipse pattern according to an example embodiment, and FIG. 4B is a graph showing luminance according to viewing angle in the lenticular lens of FIG. 4A;

FIG. 5A is a graph showing a graph of a cross-section of a lenticular lens having a parabola pattern, and FIG. 5B is a graph showing luminance according to a viewing angle in the lenticular lens of FIG. 5A;

FIG. 6 is a cross-sectional view illustrating a color improving film according to another example embodiment;

FIG. 7 is a cross-sectional view illustrating a color improving film according to another example embodiment;

FIG. 8 shows images illustrating the evaluation of a blurring effect according to a viewing angle when color improving films according to example Embodiment 1 and Comparative Example 1 are applied;

FIG. 9 is a graph showing luminance of a color improving film according to a viewing angle, measured in example Embodiment 1 and Comparative Example 1; and

FIG. 10 is a graph showing a color change ratio (ΔU‘V’) of the color improving films according to a viewing angle, measured in example Embodiment 1 and Comparative Example 1.

### DETAILED DESCRIPTION

Reference will now be made in detail to example embodiments illustrated in the accompanying drawings, wherein like reference numerals refer to the like elements throughout. In this regard, the example embodiments may have different forms and should not be construed as being limited to the descriptions set forth herein. Accordingly, the example embodiments are merely described below, by referring to the figures.

The thicknesses or lines or sizes of components illustrated in the drawings may be exaggerated for clarity and convenience of description.

Also, the terms described below are defined in consideration of functions in the example embodiments and may vary according to the intention of a user or an operator or according to custom.

Thus, the terms should be defined based on the overall description of the present specification.

It will be understood that when an element is referred to as being “on,” “connected” or “coupled” to another element, it can be directly on, connected or coupled to the other element or intervening elements may be present. In contrast, when an element is referred to as being “directly on,” “directly connected” or “directly coupled” to another element, there are no intervening elements present. As used herein the term “and/or” includes any and all combinations of one or more of the associated listed items. Further, it will be understood that when a layer is referred to as being “under” another layer, it can be directly under or one or more intervening layers may also be present. In addition, it will also be understood that when a layer is referred to as being “between” two layers, it can be the only layer between the two layers, or one or more intervening layers may also be present.

It will be understood that, although the terms “first”, “second”, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of example embodiments.

In the drawing figures, the dimensions of layers and regions may be exaggerated for clarity of illustration. Like reference numerals refer to like elements throughout. The same reference numbers indicate the same components throughout the specification.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of example embodiments.

Unless otherwise defined, all terms (including technical and scientific terms) used herein have the same meaning as commonly understood by one of ordinary skill in the art to which example embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein. As used herein, expressions such as “at least one of,” when preceding a list of elements, modify the entire list of elements and do not modify the individual elements of the list.

Although corresponding plan views and/or perspective views of some cross-sectional view(s) may not be shown, the cross-sectional view(s) of device structures illustrated herein provide support for a plurality of device structures that extend along two different directions as would be illustrated in a plan view, and/or in three different directions as would be illustrated in a perspective view. The two different directions may or may not be orthogonal to each other. The three different directions may include a third direction that may be orthogonal to the two different directions. The plurality of device structures may be integrated in a same electronic device. For example, when a device structure (e.g., a memory cell structure or a transistor structure) is illustrated in a cross-sectional view, an electronic device may include a plurality of the device structures (e.g., memory cell structures or transistor structures), as would be illustrated by a plan view of the electronic device. The plurality of device structures may be arranged in an array and/or in a two-dimensional pattern.

Reference will now be made in detail to embodiments, examples of which are illustrated in the accompanying drawings, wherein like reference numerals refer to the like elements throughout. In this regard, the present embodiments may have different forms and should not be construed as being limited to the descriptions set forth herein. Accordingly, the embodiments are merely described below, by referring to the figures, to explain example embodiments of the present description.

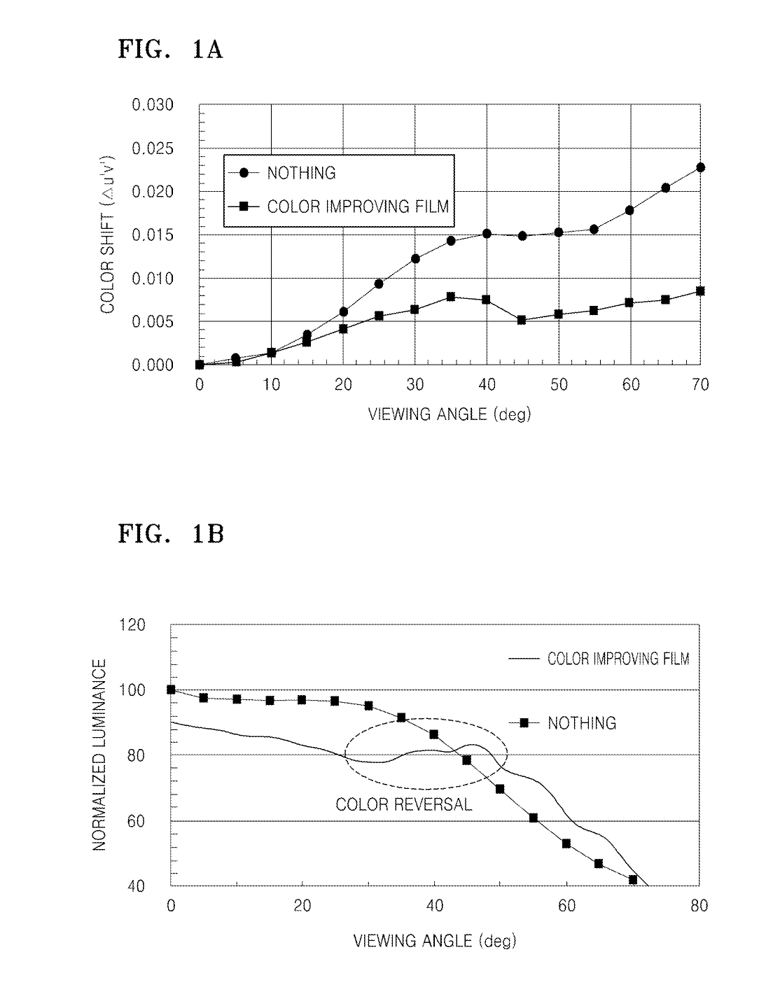

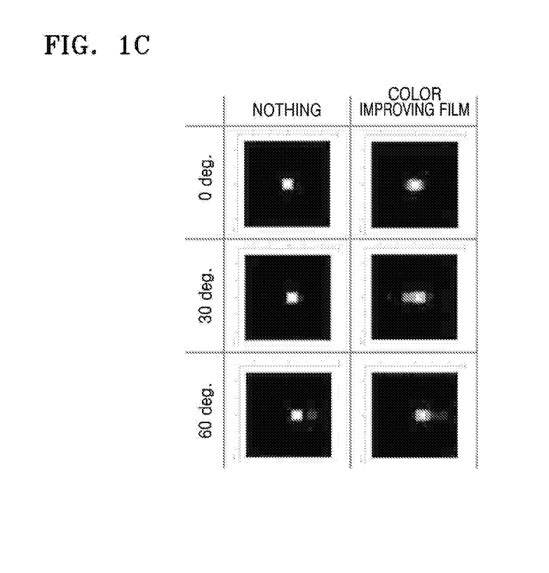

FIGS. 1A through 1C are graphs respectively showing a color change ratio, a luminance change ratio, and a blurring effect of a panel to which a color improving film is applied according to an example embodiment, and of a bare panel to which no color improving film is applied, with respect to a viewing angle. Referring to FIG. 1A, compared to when no color improving film is applied, a color change ratio (ΔU‘V’) is reduced when a color improving film is applied. However, a color reversal phenomenon in which luminance of a display becomes abruptly bright and then dark again at around 40-50 degrees may occur as shown in FIG. 1B, which may be undesired. Also, when a color improving film is applied, as illustrated in FIG. 1C, a blurring phenomenon, where viewers see pixels as not elaborate but as being spread out, may be caused.

According to the color improving film of the example embodiments described below, a color improving effect may be obtained, and additionally, a color reversal phenomenon and a blurring effect may be prevented.

### Color Improving Film

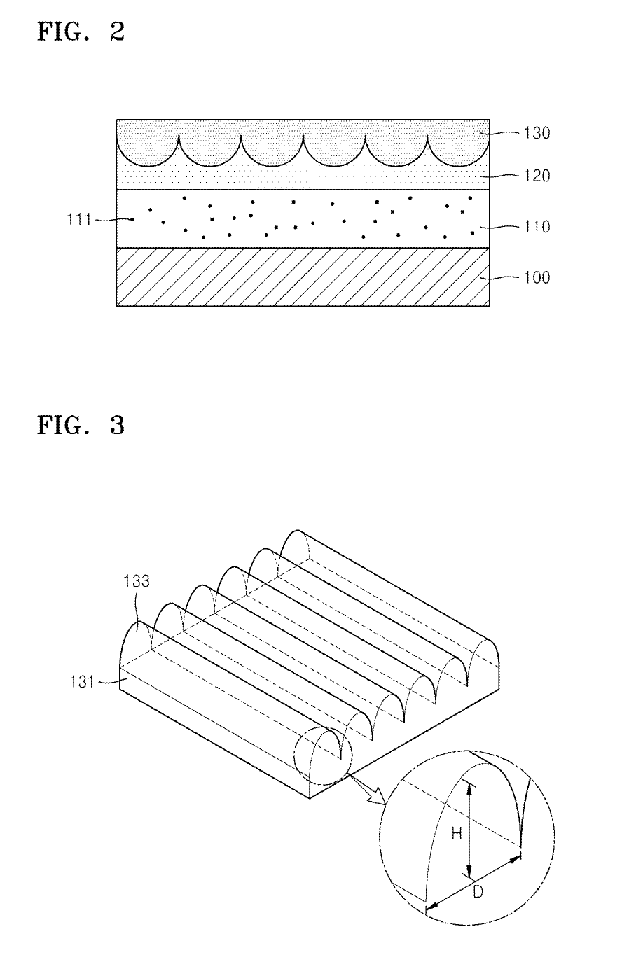

FIG. 2 is a cross-sectional view illustrating a color improving film according to an example embodiment. Referring to FIG. 2, the color improving film has a structure in which a base layer 100, a high refractive light diffusion layer 110 including a light diffuser 111, a high refractive resin layer 120, and a low refractive resin layer 130 including a lenticular lens pattern are sequentially stacked, wherein the lenticular lens pattern is formed on a surface of the low refractive resin layer 130 facing the high refractive resin layer 120.

The color improving film may satisfy Formula 1 below, and may satisfy a range of differences (Δn) in refractive indices below.

0.10<Δn<0.20, Δn=n1−n2 [Formula 1]

In Formula 1, n1 denotes a refractive index of the high refractive resin layer 120, and n2 denotes a refractive index of the low refractive resin layer 130.

The base layer 100 may be formed of a transparent resin film or a glass substrate that has a light incident surface and a light exit surface facing the light incident surface, and having ultraviolet transmittivity. The base layer 100 may be formed of a material such as, e.g., triacetate cellulose (TAC), a polyethylene terephthalate (PET), polycarbonate (PC), or a poly vinyl chloride (PVC) and may be a single layer or a plurality of layers.

The base layer 100 may have a thickness of about 30 μm to about 200 μm.

The high refractive light diffusion layer 110 may be stacked on the light incident surface of the base layer 100, and may be formed of, or include, a light diffuser and an ultraviolet hardening transparent resin having a refractive index of about 1.50 to about 1.60. The high refractive light diffusion layer 110 may have a thickness of about 5 μm to about 60 μm.

The light diffuser 111 included in the high refractive light diffusion layer 110 may be an organic light diffuser, an inorganic light diffuser, or a mixture of organic and inorganic light diffuser to provide light diffusion and transmittivity. The organic light diffuser may be formed of acrylic particles, siloxane-based particles, melamine-based particles, polycarbonate-based particles, styrene particles, or a mixture of any of the above particles. The organic light diffuser may be or include spherical cross-linking minute particles having an average particle diameter of about 1 μm to about 20 μm.

The light diffuser 111 according to an example embodiment may be included in the high refractive light diffusion layer 110 in about 0.1 wt % to about 10 wt %.

The high refractive resin layer 120 may be disposed between the high refractive light diffusion layer 110 and the low refractive resin layer 130 in which an optical pattern that faces the high refractive light diffusion layer 110 is formed.

Light having a relatively high color purity among light incident on a panel may be emitted in a direction perpendicular to the light exit surface, and to spread the incident light having a relatively high color purity, the optical pattern may use a lenticular lens pattern.

The high refractive resin layer 120 may include an ultraviolet hardening transparent resin having a refractive index of about 1.50 to about 1.60. The high refractive resin layer 120 may not have a uniform layer thickness for the optical pattern formed in the low refractive resin layer 130 to penetrate into the high refractive resin layer 120. A maximum thickness of the high refractive resin layer 120 may be about 5 μm to about 80 μm.

Referring to FIG. 2, the high refractive light diffusion layer 110, including the light diffuser 111, and the high refractive resin layer 120 may be formed separately, or alternatively, the high refractive light diffusion layer 110 and the high refractive resin layer 120 may be integrated as a single unit as a layer 160 illustrated in FIG. 7.

The low refractive resin layer 130, in which a lenticular lens pattern is formed, includes a low refractive resin layer and a plurality of lenticular lens patterns formed on a surface of the low refractive resin layer 130. The lenticular lens patterns may be formed on a surface of the low refractive resin layer 130 facing the high refractive resin layer 120.

The low refractive resin layer 130 and the lenticular lens pattern may be formed of a single material as a single unit without any attachment using an adhesive. The lenticular lens pattern and the low refractive resin layer 130 may include an ultraviolet hardening transparent resin having a refractive index of about 1.35 to about 1.45.

FIG. 3 is a perspective view illustrating a lenticular lens pattern according to an example embodiment. Referring to FIG. 3, the lenticular lens pattern may be formed of a plurality of lenticular lenses 133 formed on a surface of a low refractive resin layer 131. The lenticular lenses 133 may have a width D of about 1 μm to about 1000 μm and a height H of about 1 μm to about 3000 μm, and a thickness of the low refractive resin layer 131, not including an optical pattern, may be about 5 μm to about 50 μm.

The lenticular lens pattern according to an example embodiment may include unit lenticular lenses having an oval cross-section.

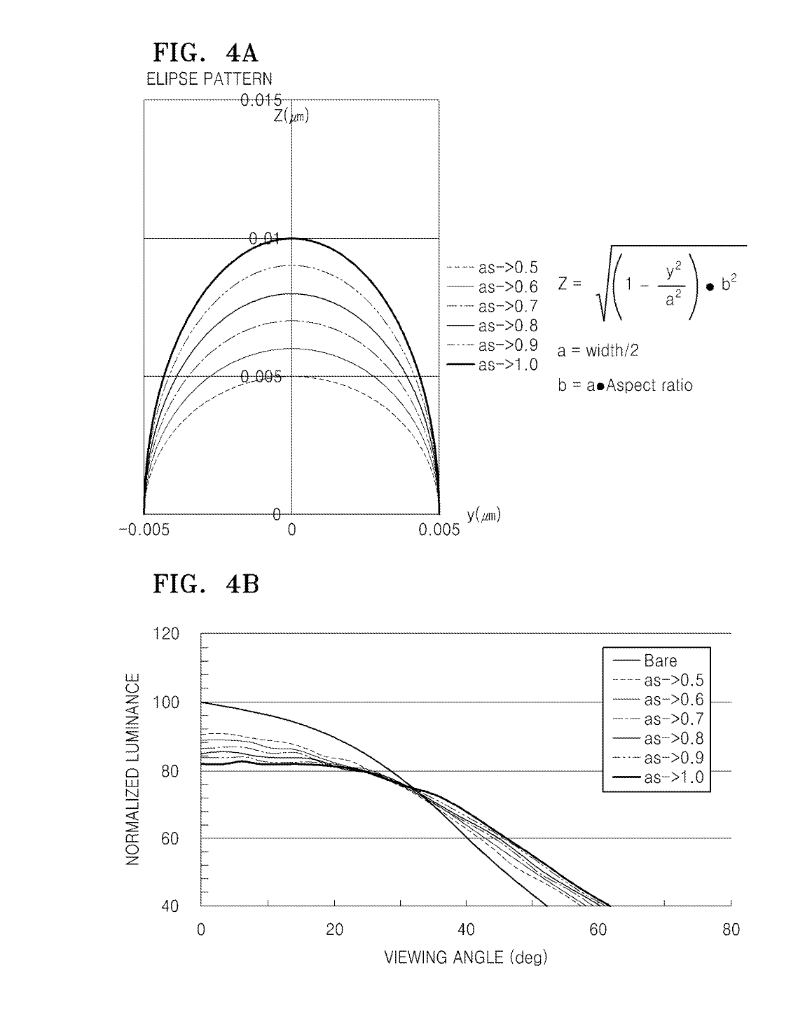

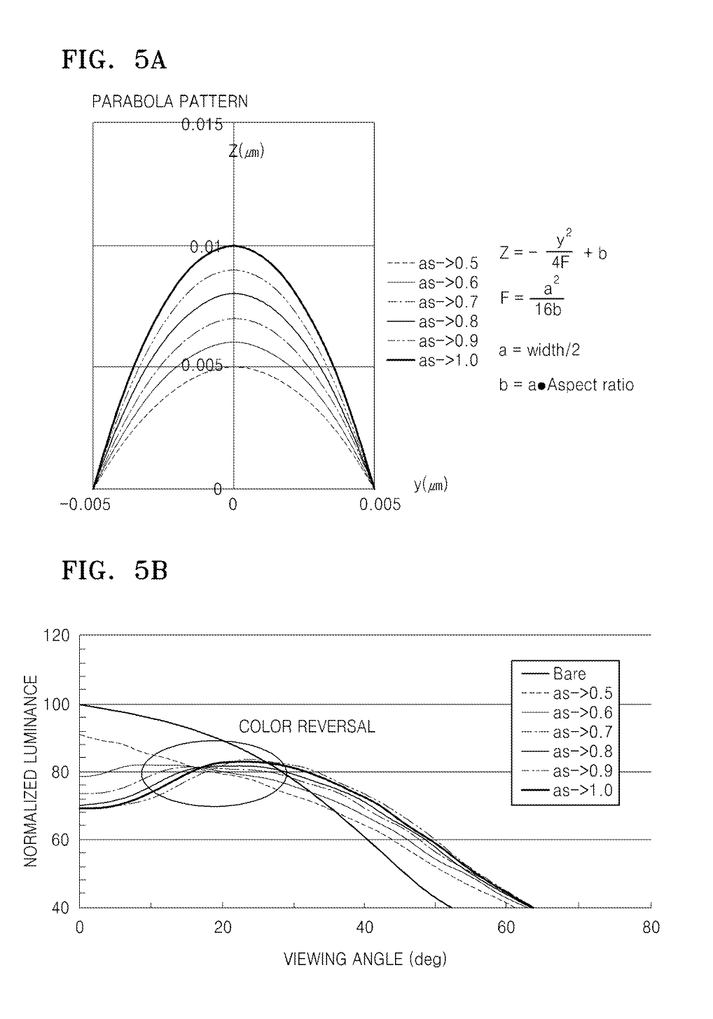

FIG. 4A is a graph illustrating a cross-section of a lenticular lens having an ellipse pattern according to an example embodiment, and FIG. 4B is a graph illustrating luminance according to a viewing angle in the lenticular lens of FIG. 4A. FIG. 5A is a graph of a cross-section of a lenticular lens having a parabola pattern, and FIG. 5B is a graph illustrating luminance according to a viewing angle in the lenticular lens of FIG. 5A.

Referring to FIGS. 4 and 5, when a graph of a lenticular lens cross-section is parabola-shaped, a color reversal phenomenon, in which the brightness of a display becomes abruptly bright and then dark again at around 10-30 degrees, occurs, but in the case of the oval lenticular lens cross-section, no color reversal phenomenon occurs. An oval lenticular lens according to an example embodiment is a lenticular lens having a cross-section which graph satisfies an oval equation illustrated in FIG. 4A.

In the oval lenticular lens pattern, an aspect ratio H/D of the lenticular lens may be about 0.3 to about 1.5, or from about 0.5 to about 1.0.

Though it is ideal to use a lenticular lens having a high aspect ratio in order to obtain a color improving effect, bite processing or rolling processing using bites may be difficult, and an increase in manufacturing costs may occur due to a sharp decrease in a yield in consideration of mass production. According to an example embodiment, good color improving effects may be obtained even by using a lenticular lens pattern having a relatively low aspect ratio, by introducing a high refractive light diffusion layer.

A basic resin used in the high refractive light diffusion layer 110, the high refractive resin layer 120, and the low refractive resin layer 130 in which an optical pattern is formed, may include an ultraviolet hardening transparent resin as a transparent polymer resin.

The ultraviolet hardening transparent resin may be, for example, a resin having an acrylate-based functional group such as polyester resin, polyether resin, acrylic resin, epoxy resin, urethane resin, alkyd resin, spiroacetal resin, polybutadiene resin, polythiol polyene resin, and (meta)acrylate resin of a multi-functional compound such as polyhydric alcohol, which have a relatively small molecular weight.

Examples of the ultraviolet hardening transparent resin may include, ethylene glycol diacrylate, neopentyl glycol di(meta)acrylate, 1,6-hexane diol(meta)acrylate, trimethylolpropane tri(meta)acrylate, dipenta erythritol hexa(meta)acrylate, polyol poly(meta)acrylate, di(meta)acrylate of bis phenol A-digylicidyl ether, poly esther (meta)acrylate which is obtainable by esterification of polyhydric alcohols, polybasic carboxylic acid and anhydrides thereof and acrylic acid, polysiloxane polyacrylate, urethane(meta)acrylate, pentaerythritol tetrametacrylate, and glycerin trimethacrylate, but is not limited to.

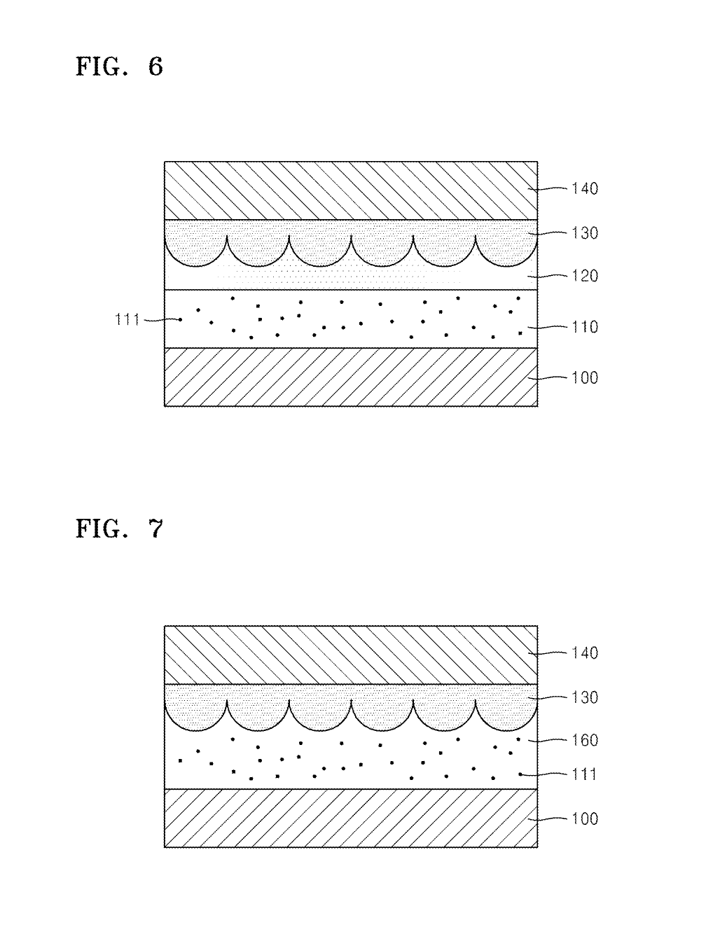

According to another example embodiment, referring to FIGS. 6 and 7, an adhesive layer 140 may be formed on the other surface of the low refractive resin layer 130. The adhesive layer 140 may be formed of, or include, a typical adhesive.

### Method of Manufacturing Color Improving Film

A method of manufacturing a color improving film, according to an example embodiment, includes sequentially stacking a base layer, a high refractive light diffusion layer, a high refractive resin layer, and a low refractive resin layer in which a lenticular lens pattern is formed. The example method includes forming a high refractive light diffusion layer by spreading a resin including a light diffuser on a surface of a base layer and hardening the resin, forming a high refractive resin layer comprising an engraved lenticular lens pattern on a surface of the high refractive light diffusion layer, and forming a low refractive resin layer having an optical pattern in a surface of the low refractive resin layer by spreading a low refractive transparent resin on a surface of the high refractive resin layer, in which a lenticular lens pattern is engraved, and hardening the low refractive resin layer.

According to another example embodiment, the method may further include forming an adhesive layer by spreading an adhesive on the other surface of the low refractive resin layer.

The transparent resin may be formed of an ultraviolet hardening transparent resin. A high refractive transparent resin may have a refractive index of about 1.50 to about 1.60, and a low refractive transparent resin may have a refractive index of about 1.35 to about 1.45.

The high refractive light diffusion layer may be formed by sufficiently dispersing a light diffuser in a high refractive ultraviolet hardening transparent resin and spreading the high refractive ultraviolet hardening transparent resin, in which the light diffuser is dispersed, on a surface of a base layer by using a planarization roller and hardening the layer formed on the surface of the base layer. A thickness of the high refractive ultraviolet hardening transparent resin may be about 20 μm to about 30 μm. When the thickness exceeds 30 μm, an amount of the light diffuser may be too high so that a degree of light scattering may be high and thus light transmittivity may be decreased. When the thickness is less than 20 μm, a surface of the high refractive light diffusion layer may be rough due to a size of the light diffuser so that an adhesive force with respect to a film and light diffusion may not be sufficiently ensured.

The high refractive resin layer may be formed by spreading a high refractive transparent resin on a surface of the high refractive light diffusion layer, and using a hard mold method using an engraving roller, in which an optical pattern is embossed, or a soft mold method using a film, in which an optical pattern is embossed. Also, the high refractive resin layer may be formed by using a hardening process such as ultraviolet ray radiation after forming an engraved optical pattern.

Hereinafter, a structure and a function of the color improving film according to example embodiments will be described in further detail. However, the example embodiments should not be construed so that the inventive concepts are limited by the example embodiments.

Description being sufficiently inferred by one of ordinary skill in the art will be omitted here.

### Embodiment 1

After forming a color improving film in which the respective layers described below are sequentially stacked, properties of the color improving film were evaluated and listed in Table 1 below.

A base layer: As the base layer, a TAC film that (available at Fuji Films) has a thickness of about 60 μm was used.

A high refractive light diffusion layer: The high refractive light diffusion layer was formed using an ultraviolet hardening transparent acrylic resin (available at Aekyung Chemicals, RS1400), in which about 1 wt % of silicon-based particles (available by Cheil Industries, Inc. SL-200), which are non-coated particles, and about 1 wt % of acrylic particles (available at Sekisui, xx-2740Z), which are coated with black pigments, are dispersed as an organic light diffuser. The high refractive light diffusion layer has a refractive index of about 1.52 and a thickness of about 30 μm.

A high refractive resin layer: The high refractive resin layer was formed of an ultraviolet transparent acrylic resin, with a refractive index as shown in Table 1 below and a maximum thickness of about 40 μm.

A low refractive resin layer including an optical pattern: The low refractive resin layer including an optical pattern was formed by continuously arranging a plurality of hemispheric lenticular lenses on a surface of a low refractive resin layer formed using an ultraviolet hardening transparent acrylic resin having a refractive index as shown in Table 1 below (distance L=0). The low refractive resin layer and the lenticular lenses are integrated as a single unit, the low refractive resin layer had a thickness of about 30 μm, and the lenticular lenses are similar to the oval lenticular lenses of FIG. 4 with a width D of about 10 μm, a height H of about 10 μm, and an aspect ratio H/D of about 1.0.

### Embodiments 2-4 and Comparative Examples 2 and 3

A color improving film was formed in the same manner as in example Embodiment 1 except that refractive indices of the low refractive resin layer and of the high refractive resin layer, and the types and aspect ratios of the lenticular lenses were as shown in Table 1 below.

### COMPARATIVE EXAMPLE 1

A color improving film was prepared in the same manner as in example Embodiment 1 except that refractive indices of low refractive resin layer and of the high refractive resin layer, and the types and aspect ratios of lenticular lenses were as shown in Table 1 below, except that the lenticular lenses were separated from one another. Properties of the color improving film were then evaluated and listed in Table 1.

### Method of Evaluating Properties

Front Transmittivity (%): The prepared color improving film was cut in a size of 5 cm×5 cm, light is subsequently allowed to be incident on a surface of the low refractive resin layer exposed to the outside, and the front transmittivity of the color improving film was measured using NDH5000W (Nippon Denshoku Industries, Co., Ltd) according to ASTM D1003.

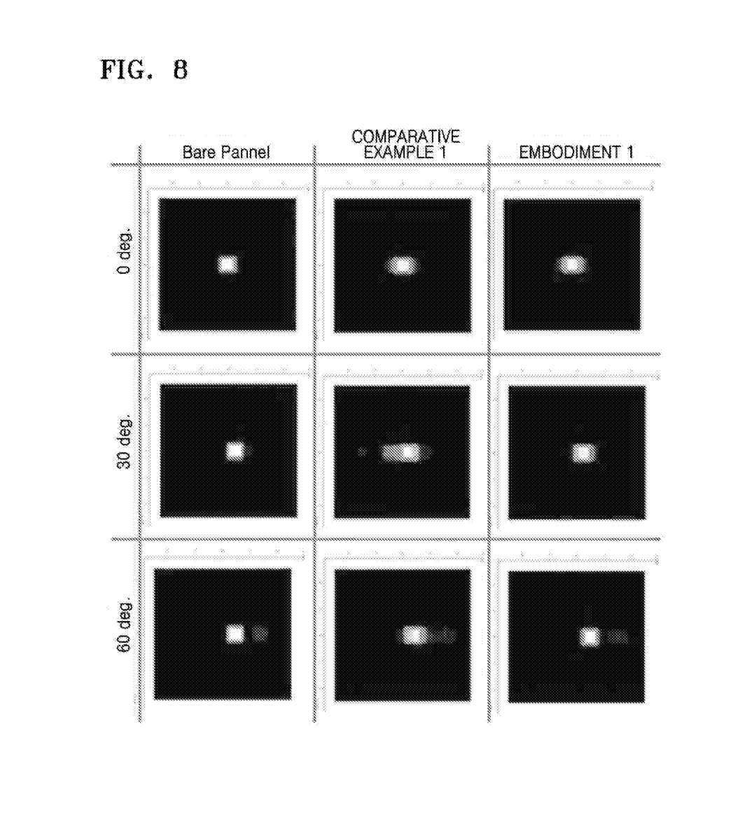

Method of Evaluating Blurring: An organic light-emitting display including optical films according to the example Embodiments and the Comparative examples was driven to display a test pattern displayed by a scanning line of a panel on the optical films, an image of the displayed test pattern was captured using light-tools, and blurring was evaluated based on the obtained image. FIG. 8 shows images showing blurring effects according to a viewing angle when color improving films according to example Embodiment 1 and Comparative example 1 were applied. [×: slight blurring, Δ: blurring is generated, ◯: strong blurring is generated]

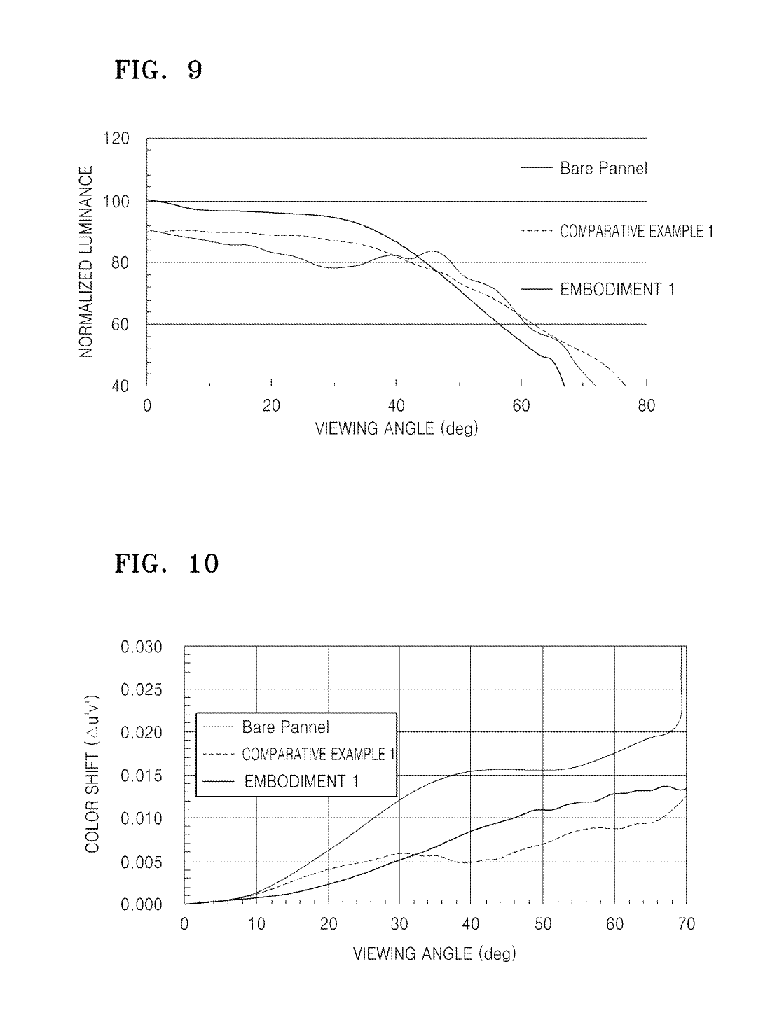

Color Change Ratio (ΔU‘V’): The films according to the example Embodiments and the Comparative Examples were cut in a size of 20 cm×20 cm, and were attached on an OLED TV panel, and a measuring device EZcontrast (available by Eldim) was used to obtain color coordinates distribution values measured in all directions with respect to a center of the panel. Values from 0° to 60° were listed separately from among a measuring result to calculate a color change ratio ΔU‘V’ with respect to a viewing angle of 0° . The color change ratio was evaluated after attaching a circular polarization film on a color improving film of the example Embodiments and of the Comparative Examples to a display panel. FIG. 9 is a graph showing a color change ratio (ΔU‘V’) in luminance of a panel, to which a color improving film is attached, according to example Embodiment 1 and Comparative Example 1, and luminance of a panel, to which a color improving film is not attached.

Evaluation of Color Reversal: The films according to the example Embodiments and the Comparative Examples were cut in a size of 20 cm×20 cm, and were attached on an OLED TV panel, and a measuring device EZcontrast (available by Eldim) was used to obtain luminance values according to the viewing angle with respect to a center of the panel, and to determine whether a phenomenon where luminance of a display becomes abruptly bright and then dark again about a viewing angle of 10° to 50° occurs. FIG. 9 is a graph showing luminance values of panels, to which films of example Embodiment 1 and Comparative example 1 is attached, and of a panel, to which no film is attached. [◯: no color reversal, ×: color reversal is present]

TABLE 1

| | | Embodiment | Embodiment | Embodiment | Embodiment | Comparative | Comparative | Comparative |
|---|---|---|---|---|---|---|---|---|
| | | 1 | 2 | 3 | 4 | example 1 | example 2 | example 3 |
| Refractive | High refractive | 1.60 | 1.60 | 1.58 | 1.60 | 1.60 | 1.60 | 1.60 |
| index | resin layer (n1) | | | | | | | |
| | Low refractive | 1.44 | 1.41 | 1.39 | 1.48 | 1.41 | 1.44 | 1.35 |
| | resin layer (n2) | | | | | | | |
| | Δn = n1 − n2 | 0.16 | 0.19 | 0.19 | 0.12 | 0.19 | 0.16 | 0.25 |
| Lenticular | Aspect ratio (H/D) | 0.80 | 0.50 | 0.50 | 0.80 | 2.4 | 0.80 | 0.50 |
| lens | Distance | None | None | None | None | Present | None | None |
| | Type | Oval | Oval | Oval | Oval | Parabolic | Parabolic | Oval |
| Front transmittivity (%) | | 89.8 | 92.1 | 91.7 | 93.1 | 90.3 | 70.1 | 85.1 |
| Blurring degree | | X | X | X | Δ | ◯ | ◯ | Δ |
| Color reversal effect | | X | X | X | X | ◯ | ◯ | X |
| ΔU′V′ | 60° | 29 | 31 | 31 | 29 | 51 | 58 | 48 |
| | 30-60° (avg.) | 38 | 29 | 28 | 29 | 58 | 66 | 53 |

As shown in Table 1 above, a difference (Δn) in refractive indices satisfied Formula 1, a range of aspect ratio was from about 0.3 to about 1.5, and an aspect ratio of example Embodiments 1 through 4, which include oval lenticular lenses. Example Embodiments 1 through 4 have an improved front transmittivity and minimized blurring, no color reversal, and a reduced color change ratio according to a viewing angle, compared to Comparative Example 1, in which adjacent lenticular lenses are separated and an aspect ratio exceeds 0.15, and Comparative example 3, in which Δn is outside Formula 1, and Comparative examples 1 and 2 in which a lenticular lens is parabola-shaped.

It should be understood that the example embodiments described therein should be considered in a descriptive sense only and not for purposes of limitation. Descriptions of features within each example embodiment should typically be considered as available for other similar features in other example embodiments.

While one or more example embodiments of the present invention have been described with reference to the figures, it will be understood by those of ordinary skill in the art that various changes in form and details may be made therein without departing from the spirit and scope of the example embodiments as defined by the following claims.

What is claimed is:

1. A color improving film comprising:
a base layer;
a high refractive light diffusion layer including a light diffuser on the base layer;
a high refractive resin layer on the high refractive light diffusion layer; and
a low refractive resin layer in which a lenticular lens pattern is formed on the high refractive resin layer,
wherein the lenticular lens pattern is formed on a surface of the low refractive resin layer facing the high refractive resin layer, and a unit lenticular lens of the lenticular lens pattern is an oval lenticular lens, and
wherein the color improving film satisfies Formula 1:
0.10<Δn<0.20, Δn=n1−n2, [Formula 1]
where n1 denotes a refractive index of the high refractive resin layer, and n2 denotes a refractive index of the low refractive resin layer.

2. The color improving film of claim 1, wherein the oval lenticular lens pattern has a width D of 1 μm to 1000 μm, a height H of 1 μm to 3000 μm, and an aspect ratio H/D of 0.3 to 1.5.

3. The color improving film of claim 1, wherein the light diffuser comprises an organic light diffuser, an inorganic light diffuser, or a combination thereof, and
wherein the organic light diffuser comprises at least one of acrylic particles, siloxane-based particles, melamine-based particles, polycarbonate-based particles, and styrene-based particles.

4. The color improving film of claim 3, wherein the organic light diffuser comprises spherical particles having an average particle diameter (D50) of about 1 μm to about 20 μm.

5. The color improving film of claim 1, wherein the light diffuser is included in the high refractive light diffusion layer at a concentration of about 0.1 wt % to about 10 wt %.

6. The color improving film of claim 1, wherein the high refractive light diffusion layer and the high refractive resin layer comprise an ultraviolet hardening transparent resin having a refractive index of about 1.50 to about 1.60.

7. The color improving film of claim 1, wherein the low refractive resin layer comprises an ultraviolet hardening transparent resin having a refractive index of about 1.35 to about 1.45.

8. The color improving film of claim 1, wherein the lenticular lens pattern and the low refractive resin layer are formed as a single unit.

9. The color improving film of claim 1, wherein the high refractive light diffusion layer, which includes the light diffuser, and the high refractive resin layer are formed as a single unit.

10. The color improving film of claim 1, wherein the high refractive resin layer and the low refractive resin layer comprise an ultraviolet hardening resin having an acrylate functional group.

11. The color improving film of claim 1, wherein a thickness of the base layer is about 30 μm to about 200μm, a thickness of the high refractive light diffusion layer is about 5 μm to 60 μm, a maximum thickness of the high refractive resin layer is about 5 μm to 80 μm, and a thickness of the low refractive resin layer is about 5 μm to 50 μm.

12. The color improving film of claim 1, further comprising an adhesive layer on another surface of the low refractive resin layer.

13. The color improving film of claim 1, wherein the base layer comprises triacetate cellulose (TAC), polyethylene terephthalate (PET), polycarbonate (PC), or poly vinyl chloride (PVC).

14. An organic light-emitting display comprising the color improving film of claim 1.

15. A method of manufacturing a color improving film, the method comprising:
forming a high refractive light diffusion layer by spreading a resin including a light diffuser on a surface of a base layer, and hardening the resin;
forming a high refractive resin layer including an engraved lenticular lens pattern, on a surface of the high refractive light diffusion layer; and
forming a low refractive resin layer by spreading a low refractive transparent resin on a surface of the high refractive resin layer, in which a lenticular lens pattern is engraved, and hardening the low refractive transparent resin layer so that the low refractive resin layer has a lenticular lens pattern on a surface thereof.

16. The method of claim 15, further comprising forming an adhesive layer by spreading an adhesive on the other surface of the low refractive resin layer.

17. The method of claim 15, wherein the high refractive resin layer comprises an ultraviolet hardening transparent resin having a refractive index of about 1.50 to about 1.60, and the low refractive transparent resin comprises an ultraviolet hardening transparent resin having a refractive index of about 1.35 to about 1.45.

18. The method of claim 15, wherein a unit lenticular lens of the lenticular lens pattern is an oval lenticular lens, and
wherein the color improving film satisfies Formula 1:
(0.10)<Δn<(0.20), Δn=n1−n2, [Formula 1]
where n1 denotes a refractive index of the high refractive resin layer, and n2 denotes a refractive index of the low refractive resin layer.

19. The method of claim 18, wherein an aspect ratio H/D of the oval lenticular lens is about 0.3 to about 1.5.
